(19) United States
(12) Patent Application Publication
(10) Pub. No.: US 2010/0287799 A1
(43) Pub. Date: Nov. 18, 2010

(54) Microphone air sensor card

(76) Inventor: Timothy Clegg, Manhattan Beach, CA (US)

Correspondence Address: LAW OFFICES OF CLEMENT CHENG, 17220 NEWHOPE STREET #127, FOUNTAIN VALLEY, CA, 92708, US

(21) Appl. No.: 12/454,139

(22) Filed: May 13, 2009

(51) Int. Cl. G09F 1/00; H04R 3/00

(52) U.S. Cl. 40/124.02; 381/122

(57) ABSTRACT

A microphone air sensor card has a microphone, a circuit having an integrated circuit, a memory, a first transistor and a second transistor. The microphone is biased by a VDD so that the first transistor and the second transistor activate as switches to relay a microphone signal to a microphone input on the integrated circuit. A light element is also included. The integrated circuit turns off the light element when the microphone hears airflow. A primary page and a secondary page house the circuit. The secondary page has an inside portion and an outside portion. The circuit and light element are both disposed within the secondary page between the inside portion and the outside portion.

### DISCUSSION OF RELATED ART

Greeting cards and magazine inserts have been supplemented with a variety of improvements, such as audio messages that are activated by tongue switch activated on the opening or closing of a panel of the device. U.S. Pat. No. 7,240,442 issued to Clegg on Jul. 10, 2007 provides for a folding magazine insert having audio capabilities, the disclosure of which is incorporated in its entirety by reference herein. The prior art generally includes a battery pack, a memory module, a switch and a speaker. When the switch is activated, the speaker plays a tune or message stored on the memory module. Additionally, lights have also been added to greeting cards and magazine inserts.

Inventor Nicolas Helou in U.S. Pat. No. 7,300,178 issued Nov. 27, 2007 provided for a bimetallic strip air sensor that is activated by a user to control an integrated circuit to operate the module for activating lights or sound, the disclosure of which is incorporated herein by reference. The abstract describes the invention as, “A greeting card device which enables, by blowing, an LED to be switched off or a sound module (music, voice or noise) to be activated or deactivated, or a combination of a light and a sound to be activated or deactivated simultaneously. The device is composed of a bimetallic strip system, which the user blows on as if blowing out a candle, and which is connected to the integrated circuit of the LED or the sound module or both, as well as to a resistor and a capacitor which, by charging and discharging, allows switching on-switching off cycles to be repeated. The device according to the invention is particularly suited to the animation of greeting cards (birthdays, Christmas, etc.).” Unfortunately, the patent does not describe how to manufacture the bimetallic strip sensor to be reliable at a low cost suitable for manufacturing disposable paper products such as greeting cards and magazine inserts. A bimetallic strip is generally a strip that has a lamination of two sheets of different kinds of metals.

Additionally, other pre-programmed or programmable talking greeting cards have been the objects of a number of patents. For example, Barnett et al. (U.S. Pat. No. 3,462,157) teaches an audible greeting card comprising a pair of panel members, the first panel carrying a sound track, and the second one having a sound pick-up member and an amplifier speaker which is actuated by the sound pick-up member. Other prior patents include Deffner (U.S. Pat. No. 4,035,941) who teaches an audio-visual display device which sequentially displays and describes merchandise. A timer is used to control the operation of a plurality of electrical audio and visual display components. Tarrant et al. (U.S. Pat. No. 4,222,188) teaches a sound reproducing device for either music or speech combined with a display for an opaque sheet on which an insignia is defined that may be a work of art, photograph, printed material or the like. The display is a part of a resonator box that not only amplifies the volume of the sound reproducing device, but provides a number of spaced recesses in the upper portion thereof in which merchandise such as cosmetics or the like may be displayed. Bearden (U.S. Pat. No. 4,381,558) teaches another talking greeting card, this one having a front display panel and two rear panels adapted to hold the front panel bowed in convex shape by tabs which secure the rear panels together. A flexible sound recording strip extends through a slot in the bowed front panel and has a surface prepared to produce sounds when a sliding element, such as the thumbnail of a user, moves along the surface. The bowed front wall and overlapping rear walls amplify the sound. Calloway et al. (U.S. Pat. No. 4,611,262) teaches an electrical circuit package for greeting cards which provides an electrical circuit via a stamped and formed lead frame supported and insulated in a dielectric housing. When activated, the electrical circuit causes a piezoelectric transducer to generate audio signals in the form of a musical tone, spoken words or both.

Montgomery et al. (U.S. Pat. No. 4,703,573) teaches a visual and audible activated work comprising at least two pivotably turnable pages. A visual image display is affixed to at least one of the pages. The visual image display has first and second visual activation states; the first visual activation corresponds to no visual image and the second visual activation state provides a visual image on the visual display. A sound generator is also attached to the work. Electrical control means are connected to the visual display to selectively activate the visual display from one of the visual activation states to another upon pivoting the pages from the open position to the closed position; and the same or similar control means are connected to the sound generator to selectively activate the sound generator to create sound upon pivoting the pages from the closed position to the opened position. Photovoltaic or solar cells are taught for providing power to the audio and/or visual portions of this work.

Kondo (U.S. Pat. No. 4,791,741) teaches card or postal media which can record and playback messages or music, such media being particularly useful to allow the mailer to record his/her own messages or desired music, so that the recipient can easily play them back. The card comprises electrical means (RAM, including one or more microchips) for storing audio information picked up by a microphone; means for generating sound including a speaker; means for producing a mode selection signal corresponding to either a record mode or a playback mode; electrical control means including a TOSHIBA TC 8830 microchip for selectively setting either of the record or playback modes according to the mode selection signal from the signal producing means, converting audio from the microphone from analog to digital and storing it in the storage means when the record mode is selected, retrieving stored information from the storage means converting it from digital to analog, and outputting the analog signal to the generating means when the playback mode is selected; and a card board on which each of the above are mounted.

Hoshi (U.S. Pat. No. 4,934,079) teaches a display device including a display panel having a recorder/playback combination and a sensor that is sensitive to light, sound, heat and/or other stimuli. When approaching the panel, objects which are transparent to or shield light and/or which generate sound or heat will automatically actuate the sensor to automatically actuate the recorder/playback combination, thereby producing music or sound from the display panel. The recorder/playback combination can be made thin, small and inexpensive by the use of an IC memory. An on-off switch may be substituted for the sensor. If the sensors are made integral with the recorder/playback combination, then it is possible to obtain increased efficiency and make handling much easier. The use of an IC memory chip for the sound generating source permits free selection of sounds or music. The sounds or music are recordable on the IC chip by an external ROM writer. Playback is obtained automatically by the actuation of the on-off switch or by the sensor which is sensitive to sound, light, heat and the like to produce a sound message.

Johnson et al. (U.S. Pat. No. 5,063,698) teaches a personalized greeting card including an independent, detachable, electronic IC memory device that stores electronic signals, a mechanism for retrieving the electronic signals from the IC memory device, a voice synthesizer which obtains these electronic signals and produces audible sounds representative of the personalized message represented by the electronic signals, and a switch that controls the retrieving device and the voice synthesizer. An EPROM translator machine which converts a personalized message to electronic signals which are stored in the IC memory device separately preprograms the IC memory device. The memory device is then detached from the EPROM and mounted in the circuitry disposed in the greeting card. Both the IC memory device and the voice synthesizer are coupled to a timer by a control/power line. A battery is used to deliver power to this circuit.

Fox et al. (U.S. Pat. No. 5,245,171) teaches a mailing piece comprising a mailing envelope which has a reusable audible message generator attached thereto. The message generator may be secured (as by adhesive) to the envelope. The message generator provides an audible message which is intended to induce the recipient to retain, read and show the package to others. The envelope has a tab extending therefrom which, when pulled by the recipient, exposes an operating element to activate a talking device which gives a short message. A solar cell or other sensor responsive to light that acts to close (or to power) the electrical circuit of the message generator may be used to activate the message generator when the tab is pulled up to expose that sensor to light.

Clegg (U.S. Pat. No. 5,275,285) teaches an audio signal emitting receptacle comprising a sound emitting means and a foldable support structure suitable for holding a business card, credit card, or the like. When the receptacle is opened, an audio signal emitting means is activated by a slide tongue mechanism. Such a device, however, is not well suited for insertion into a printed, bound document such as a magazine, and would be prohibitively expensive to assemble into an outer magazine insert due to its specialized nature of holding a business card or the like.

### SUMMARY OF THE INVENTION

The object of this invention is to have an airflow sensor enabled paper graphic card, such as a greeting card, or magazine insert that is inexpensive enough for mass distribution. The microphone air sensor card is preferably a greeting card or magazine insert, but it could also be included as part of a pop-up book or other novelty. The microphone air sensor card can also be used in direct mail cards, promotional packages, and gift cards.

The present invention is similar in architecture to the Helou 7,300,178 and Clegg 7,240,442 references in that it has a plurality of panels, a switch for activating the memory module IC, a speaker for outputting sound, and optionally a plurality of LED elements. The present invention is an improvement over the prior art in that it uses a microphone as a switch. The microphone is biased with the VDD using a couple of transistors, resistors and capacitors.

In the preferred embodiment, the card is a birthday card with candles that are lit by LED's. The card is activated and voltage is applied to the IC when a user opens the card. When voltage is applied, the IC begins audio playback and the LED(s) flash. The tongue switch of Clegg 7,240,442 can be used to activate the voltage to the IC when the user opens the card.

The biased microphone is an active part of the overall circuit. When a user blows onto the microphone, the air concussion striking the microphone diaphragm causes a momentary change in the circuit applied to the base of Q1 whose output is tied to the base of Q2, these “mementaries” are sent to the input of the IC. The IC's logic is set up so that the momentary input is seen as a Turn Off pulse by the IC.

In layman's terms, the microphone listens for airflow and sends a signal when it hears the airflow. When the microphone hears the airflow, it sends a signal to the IC to turn off the LED's which simulates blowing out the candles.

### BRIEF DESCRIPTION OF THE DRAWINGS

FIG. 1 is a perspective exploded view physical diagram of the present invention.

FIG. 2 is a perspective view as seen by a user.

FIG. 3 is circuit diagram showing integration of the integrated circuit (IC) with the microphone.

FIG. 4 is circuit diagram showing integration of the circuit with the microphone.

FIG. 5 is circuit diagram showing integration of the circuit with the microphone and with a single transistor.

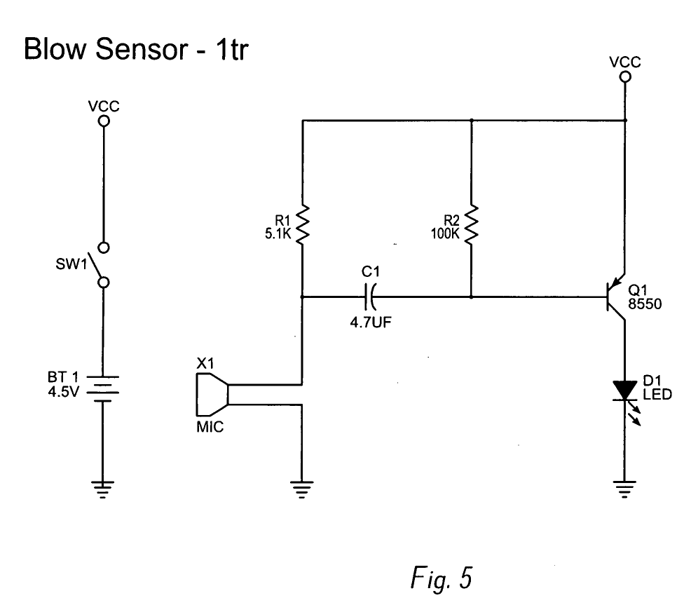

The following call out list of elements shows the
10 outside portion of secondary page
20 inside portion of secondary page
30 primary page
32 circuit
34 speaker
42 adhesive panel
130 tongue switch
185 microphone aperture
187 microphone
188 graphic
189 light

### DETAILED DESCRIPTION OF THE PREFERRED EMBODIMENT

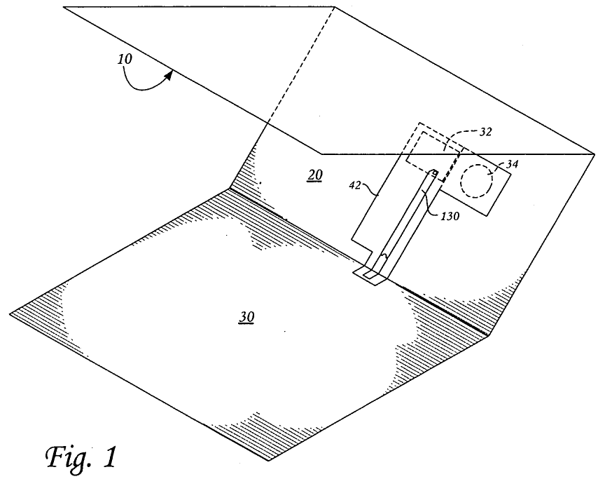

The present invention has a first page also called a primary page 30, and a secondary page joined to the primary page at a primary folding line FIG. 1. The secondary page is preferably made of a pair of flaps. The secondary page has an outside portion 10 and an inside portion 20. The outside portion 10 is joined to the inside portion 20 at a secondary page folding line.

An adhesive panel 42 preferably mounts the components onto the inside portion 20 of the secondary page. The circuit 32 is mounted to the adhesive panel 42. Additionally, a speaker 34 is also mounted to the adhesive panel 42. The tongue mechanism switch 130 acts as a power switch for the circuit 32. The adhesive panel sticks to the secondary page, and various elements are mounted to the adhesive panel. One of the various elements that can be mounted to the adhesive panel would be the speaker, or a set of batteries, or a circuit board. A circuit board can receive a circuit, which may have an integrated circuit package disposed thereon.

The tongue switch can also be replaced by some other kind of power switch such as a pushbutton when the device is a gift card rather than a magazine insert or a birthday card.

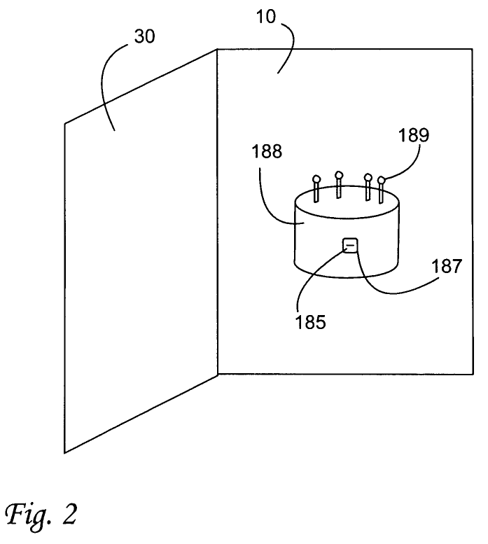

The microphone 187 is disposed within the secondary page between the outside portion 10 and the inside portion 20. A small opening on the outside portion 10 can provide airflow to the microphone 187 when a user blows on the microphone, FIG. 2. The microphone is placed near a graphic 188 and near lights 189. When a user blows on the graphic 188, the microphone 187 hears the airflow and extinguishes the lights 189. The opening on the outside portion 10 can be a slot, a plurality of small circular openings or a rectangular opening. The microphone is preferably positioned to hear air passing the opening.

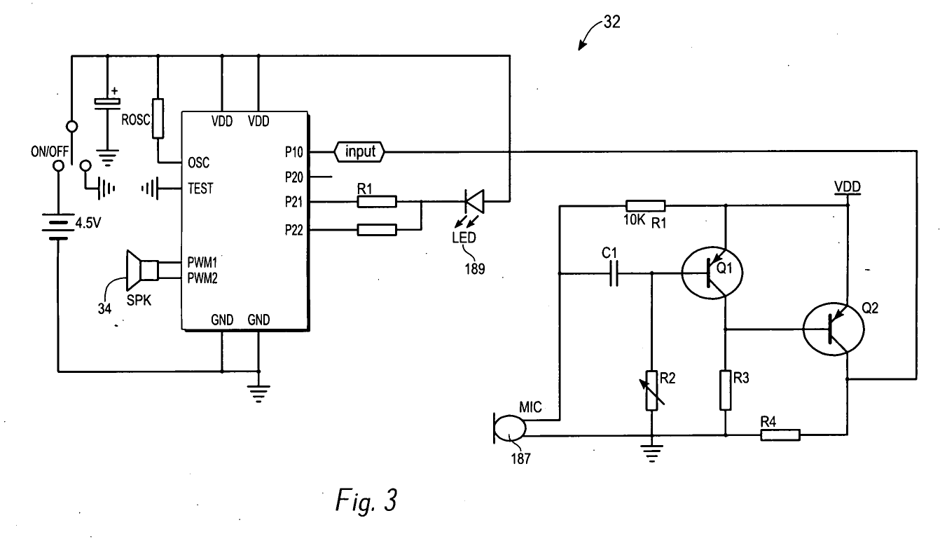

As seen in FIG. 3, the integrated circuit IC is a part of the circuit 32 and has an input P10 receiving a microphone 187 which has a voltage biased to it from the VDD. When the microphone 187 hears airflow, the first transistor Q1 and second transistor Q2 are activated like switches to relay a signal to the microphone input P10. The IC then cuts off power to P21 and P22 which extinguishes the light 189. The light is preferably one or more light emitting diodes, LED.

The speaker 34 is connected to the PWM1 and PWM2 terminals on the IC which is preferably on when the IC is powered, and off when the IC is not powered. The IC also is grounded at GND. When the IC is initially powered, the LED is powered at P21 and P22. A reserve input P20 is unused.

Therefore, in one possible application, a user blows on the microphone aperture 185 which exposes the microphone 187 to the airflow. The airflow the activates the microphone, which in turn produces a signal to the first transistor and second transistor that are activated like switches to relay a signal to the microphone input which tells the IC to turn off the LED 189. The user will see the light 198 on the birthday candles of the cake graphic 188 turn off, as seen in FIG. 2.

The graphic 188 can be something besides a birthday cake to provide a different theme for the greeting card or magazine insert. For example, a user can blow out a fire or start the rotation of a motorized pinwheel or propeller. A user could also blow off seeds of a dandelion, for example.

In addition to a light, sound and a small motor can be connected as output devices. The output devices can be triggered by the integrated circuit which is connected to the microphone output, or directly connected to the microphone in a series circuit. The apparatus can be a greeting card, an electronic gift, a direct-mail printed advertisement, or some other novelty item.

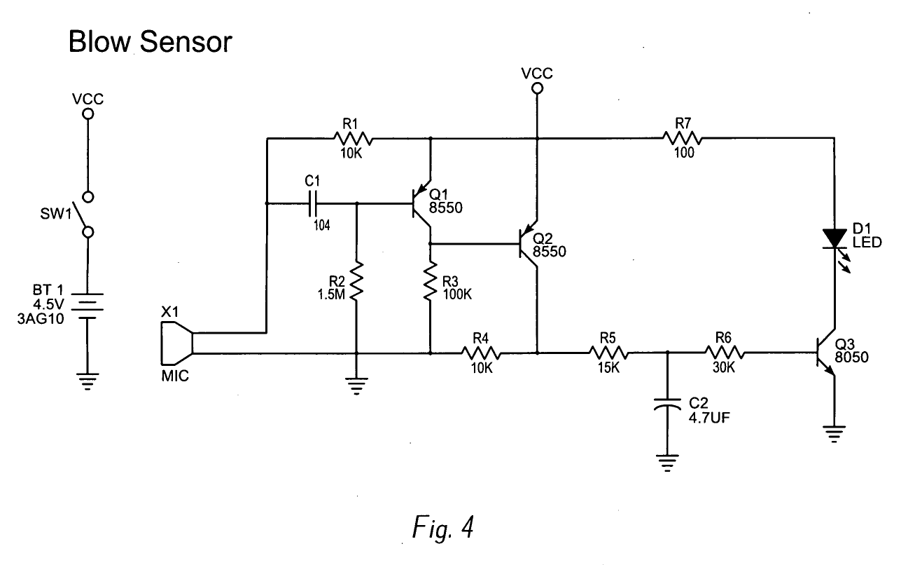

As seen in FIG. 4, which is a circuit diagram of the second embodiment, the IC can be omitted and the speaker directly used as a switch for activating light or sound on the greeting card.

Although the invention has been disclosed in detail with reference only to the preferred embodiments, those skilled in the art will appreciate that various other embodiments can be provided without departing from the scope of the invention. Accordingly, the invention is defined only by the claims set forth below.

1. A microphone air sensor device comprising:
a. a microphone configured to detect a flow of air over the microphone;
b. a circuit having a first transistor; wherein the microphone is biased by a VDD so that the first transistor activates as a switch to produce a signal output.

2. The microphone air sensor device of claim 1, further comprising: a light element; and an integrated circuit on the circuit, wherein the integrated circuit turns on or off the light element when the microphone hears airflow; a memory on the circuit; and a second transistor acting with the first transistor, wherein the second transistor relays a microphone signal to a microphone input on the integrated circuit, wherein the microphone generates a microphone signal, wherein the integrated circuit produces a signal output.

3. The microphone air sensor device of claim 2, further comprising: a primary page and a secondary page, wherein the secondary page has an inside portion and an outside portion, wherein the circuit and light element are both disposed within the secondary page between the inside portion and the outside portion.

4. The microphone air sensor device of claim 3, further comprising an opening disposed on the secondary page, wherein the microphone is positioned to detect air flow passing the opening.

5. The microphone air sensor device of claim 4, further comprising a speaker connected to the integrated circuit, wherein the integrated circuit has a pair of operating modes, namely a powered mode, and an unpowered mode, wherein the speaker outputs a sound from the memory when the integrated circuit is in the powered mode, and wherein the speaker is silent when the integrated circuit is in the unpowered mode.

6. The microphone air sensor device of claim 5, further comprising an adhesive panel, wherein the circuit is mounted to the adhesive panel, and the adhesive panel is mounted to the secondary page.

7. The microphone air sensor device of claim 2, further comprising a speaker connected to the integrated circuit, wherein the integrated circuit has a pair of operating modes, namely a powered mode, and an unpowered mode, wherein the speaker outputs a sound from the memory when the integrated circuit is in the powered mode, and wherein the speaker is silent when the integrated circuit is in the unpowered mode.

8. The microphone air sensor device of claim 7, further comprising: a primary page and a secondary page, wherein the secondary page has an inside portion and an outside portion, wherein the circuit and light element are both disposed within the secondary page between the inside portion and the outside portion.

9. A microphone air sensor card comprising:
a. a microphone configured to detect a flow of air over the microphone;
b. a circuit having an integrated circuit, a memory, one or more transistors; wherein the microphone is biased by a VDD so that the one or more transistors activate as switches to relay a microphone signal to a microphone input on the integrated circuit;
c. a light or audio element, wherein the integrated circuit turns on or off the light or audio element when the microphone hears airflow;
d. a power switch that powers on the circuit, and powers off the circuit, wherein the light element is off when the circuit is powered off and wherein the light element is on when the circuit used powered on.

10. The microphone air sensor card of claim 8, wherein the power switch is a tongue switch, and further comprising: a primary page and a secondary page, wherein the secondary page has an inside portion and an outside portion, wherein the circuit and light or audio element are both disposed within the secondary page between the inside portion and the outside portion.

11. The microphone air sensor card of claim 9, further comprising an opening disposed on the secondary page, wherein the microphone is positioned to detect air flow passing the opening.

12. The microphone air sensor card of claim 10, further comprising a speaker connected to the integrated circuit, wherein the integrated circuit has a pair of operating modes, namely a powered mode, and an unpowered mode, wherein the speaker outputs a sound from the memory when the integrated circuit is in the powered mode, and wherein the speaker is silent when the integrated circuit is in the unpowered mode.

13. The microphone air sensor card of claim 11, further comprising an adhesive panel, wherein the circuit is mounted to the adhesive panel, and the adhesive panel is mounted to the secondary page.

14. The microphone air sensor card of claim 8, wherein the power switch is a pushbutton, and further comprising a speaker connected to the integrated circuit, wherein the integrated circuit has a pair of operating modes, namely a powered mode, and an unpowered mode, wherein the speaker outputs a sound from the memory when the integrated circuit is in the powered mode, and wherein the speaker is silent when the integrated circuit is in the unpowered mode.

15. The microphone air sensor card of claim 13, further comprising: a primary page and a secondary page, wherein the secondary page has an inside portion and an outside portion, wherein the circuit and light element are both disposed within the secondary page between the inside portion and the outside portion.

16. A microphone air sensor device comprising:
a. a microphone configured to detect a flow of air over the microphone;
b. a circuit having a first transistor; wherein the microphone is biased by a VDD so that the first transistor activates as a switch to produce a signal output; and
c. an output device receiving the signal output.

17. The microphone air sensor device of claim 16, wherein the output device is a light, speaker or motor.

18. The microphone air sensor device of claim 17, further comprising: an integrated circuit on the circuit, wherein the integrated circuit turns on or off the light element when the microphone hears airflow; a memory on the circuit; and a second transistor acting with the first transistor, wherein the second transistor relays a microphone signal to a microphone input on the integrated circuit, wherein the microphone generates a microphone signal, wherein the integrated circuit produces a signal output.

19. The microphone air sensor device of claim 17, further comprising: a primary page and a secondary page, wherein the secondary page has an inside portion and an outside portion, wherein the circuit and light element are both disposed within the secondary page between the inside portion and the outside portion.

20. The microphone air sensor device of claim 18, further comprising an opening disposed on the secondary page, wherein the microphone is positioned to wherein the microphone is positioned to detect air flow passing the opening.
